(19) United States
(12) Patent Application Publication
(10) Pub. No.: US 2014/0173392 A1
(43) Pub. Date: Jun. 19, 2014

(54) HARDWARE ENFORCED PROTECTION OF SOFTWARE DATA STRUCTURES

(71) Applicant: ADVANCED MICRO DEVICES, INC., Sunnyvale, CA (US)

(72) Inventor: Michael G. DRAKE, Austin, TX (US)

(73) Assignee: Advanced Micro Devices, Inc., Sunnyvale, CA (US)

(21) Appl. No.: 13/719,937

(22) Filed: Dec. 19, 2012

(51) Int. Cl. G06F 11/08

(52) U.S. Cl. CPC G06F 11/08
USPC 714/819

(57) ABSTRACT

Methods, systems, and computer program products are provided for hardware enforced data protection mechanisms to protect software data structures. Software data structures can be protected against malicious software or software code errors that may result in data/buffer overruns or failures in computing systems. Software data structures are identified that need to be validated before they are used by software programs. A hardware mechanism receives instructions from various security privilege levels and validates an entire software data structure before the software data structure is used by software programs. Being able to detect whether a software data structure is corrupted improves defenses and security against malicious or erroneous code, provides a method for early identification, isolation, ease of debugging of software, and protects overall system integrity in computer systems and applications thereof.

### BACKGROUND

1. Field

The disclosure is generally directed to computing operations performed in a computer system and, more particularly, to hardware enforced data protection mechanisms.

2. Background Art

Computing systems typically include a main memory and a processor. The processor can read from and write to the main memory. In addition, the processor typically includes a cache memory, such that data used frequently by the processor are stored in cache memory.

Software programs and applications that run on computing systems sometimes encounter errors that may lead to data/buffer overruns and system failures. One existing solution, an error correction code (ECC) algorithm, is used to determine if data is written to and read from memory correctly. Another existing solution involves Virtual machine control block (VMCB) structures that are tied to a particular operating system (OS). OS-level microcode specific to the VMCB is limited to checking the validity of specific bits of the VMCB structure.

Accordingly, what is desired is a hardware enforced data protection mechanism to detect these errors.

### BRIEF SUMMARY

Embodiments include a method, processing unit, and computer-readable storage device for receiving a first software instruction, performing a first error detection on a software data structure to generate a first result in response to the first software instruction, storing the software data structure and the first result in memory, receiving a second software instruction, retrieving the software data structure and the first result in response to the second software instruction, performing a second error detection on the retrieved software data structure to generate a second result, and comparing the second result with the first result.

Further features and advantages, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the relevant art to make and use the embodiments.

FIG. 1 illustrates a block diagram illustrating an example computing system that includes data structure protection logic, in accordance with an embodiment.

FIG. 2 is a flowchart illustrating steps by which a software data structure is protected in accordance with an embodiment.

FIG. 3 is a flow chart illustrating steps by which a user or software developer utilizes an embodiment.

FIG. 4 is a flow chart illustrating steps by which a heterogeneous architecture structure is protected in accordance with an embodiment.

FIG. 5 depicts an example computer system in which embodiments may be implemented.

The embodiments will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following detailed description refers to the accompanying drawings that illustrate exemplary embodiments. Other embodiments are possible, and modifications can be made to the embodiments within the spirit and scope of the disclosure. Therefore, the detailed description is not meant to limit the scope. Rather, the scope is defined by the appended claims.

It would be apparent to one of skill in the art that the embodiments, as described below, can be implemented in many different embodiments of software, hardware, firmware, and/or the entities illustrated in the figures. Any actual software code with the specialized control of hardware is not limiting. Thus, the operational behavior will be described with the understanding that modifications and variations of the embodiments are possible, and within the scope and spirit of the disclosure.

Software data structures stored in main memory or in cache memory such as arrays, trees, and stacks are used by software in user applications as well as operating system (OS) functions. These data structures may become corrupted due to many reasons including malicious software such as a virus, or accidental software code errors. When this occurs, the system may not be aware of the corruption and software code may utilize data within the corrupted software data structure that ultimately leads to errors such as data/buffer overruns and system failures.

An ECC algorithm as described earlier involves the ability to determine if data within a software data structure is written to and read from memory correctly, but the algorithm does not check the integrity of the software data structure itself. Thus, even though the software data structure itself is corrupted, an ECC algorithm will not detect the corruption. In addition, ECC algorithms are also predetermined and fixed via hardware. For example, they do not adjust according to the creation of a new software data structure.

As described earlier, VMCB structures are tied to a particular operating system (OS) and OS-level microcode specific to the VMCB are limited to checking the validity of specific bits of the VMCB. The validity of the entire VMCB structure is not checked. Further, VMCB structures are accessed only by instructions that have that OS-level security privilege level. Thus these structures are not generally available for use by software program instructions that have other security privilege levels such as user applications.

Embodiments provide the following non-limiting advantages: exemplary embodiments enable computing systems to detect corruption of an entire software data structure that may otherwise not be detected; the hardware protection mechanism results in improved speed efficiencies compared to a software solution; enables isolation of problems and debugging of software code, for example, C++; the hardware protection mechanism can receive instructions at various security privilege levels to protect software data structures in various security privilege spaces, and the combination of all these exemplary embodiments provide improved defense and security against malicious software or accidental code errors.

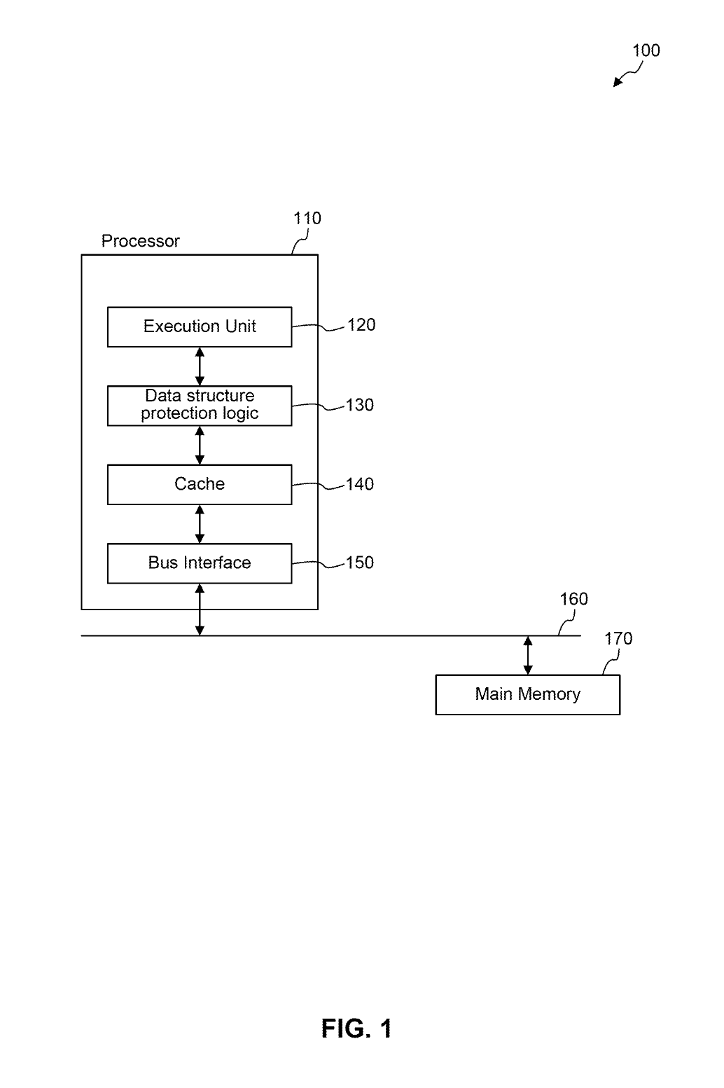

FIG. 1 illustrates a block diagram illustrating an example computing system that includes data structure protection logic, in accordance with an embodiment. In embodiments, the example computing system may comprise a supercomputer, a desktop computer, a laptop computer, a video-game console, an embedded device, a handheld device (e.g., a mobile telephone, smart phone, MP3 player, a camera, a GPS device, or the like), or some other device that includes or is configured to include a processing unit or a plurality of processing units. Although FIG. 1 illustrates a system comprising a processing unit, it is to be appreciated that this is for illustrative purposes only, and not limitation. In general, a system in accordance with an embodiment may include one or more processing units, including different types of processing units.

Processor 110 is connected to main memory 170 via bus 160. Bus 160 may be any type of communication infrastructure used in computer systems, including a peripheral component interface (PCI) bus, a memory bus, a PCI Express (PCIE) bus, front-side bus (FSB), hypertransport (HT), or another type of communication structure or communications channel whether presently available or developed in the future.

Processor 110 comprises an execution unit 120, data structure protection logic 130, cache 140, and bus interface 150. Execution unit 120 comprises one or more arithmetic logic units (ALUs) for executing instructions, as is well known in the art. Cache 140 is configured to store data and/or instructions. Storing data and/or instructions in cache 140 allows processor 110 to access the data and/or instructions faster than if it had to retrieve the data and/or instructions from main memory 170. Cache 140 may comprise a multi-tiered cache including a level-one (L1) cache, a level-two (L2) cache, and a level-three (L3) cache, as is well known in the art. Bus interface 150 includes a memory controller for controlling access to main memory 170, as is known in the art.

In an embodiment, processing unit 110 comprises data structure protection logic 130, a hardware mechanism configured to receive a first software instruction, perform a first error detection on a software data structure to generate a first result in response to the first software instruction, store the software data structure and the first result in memory, receive a second software instruction, retrieve the software data structure and the first result in response to the second software instruction, perform a second error detection on the retrieved software data structure to generate a second result, and compare the second result with the first result.

In different implementations data structure protection logic 130 may be located in the same hardware logic as load/store functions.

In another embodiment, a software data structure includes one or more of a read only software data structure, a stack structure, a heterogeneous system architecture structure, an array structure, and a tree structure. This functionality is discussed in further detail below.

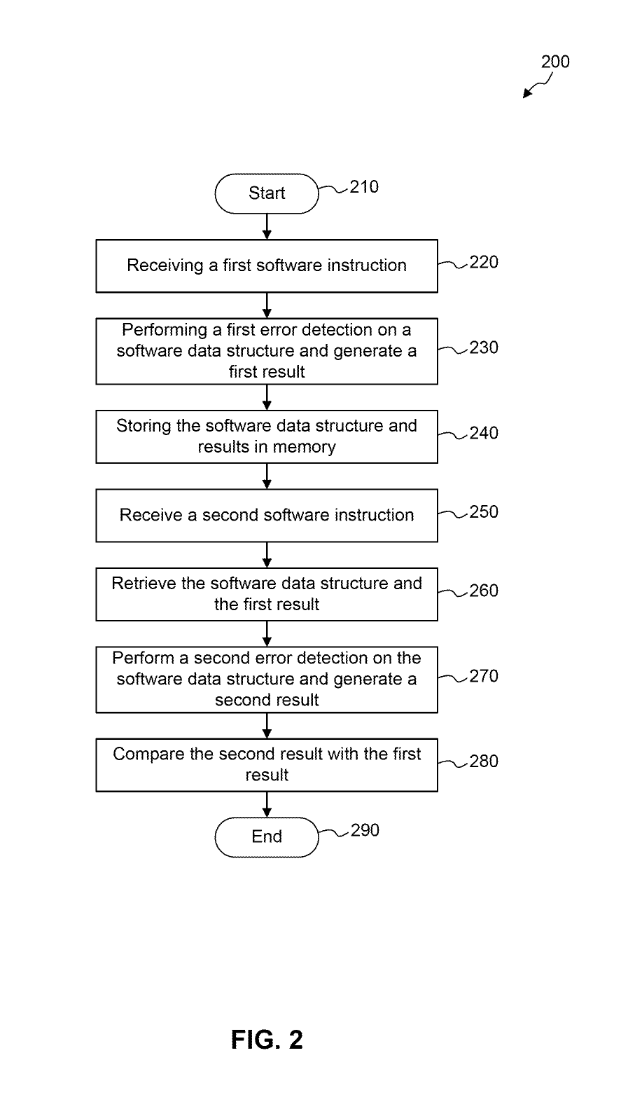

FIG. 2 is a flowchart illustrating steps by which a software data structure is protected in accordance with an embodiment. The method begins at step 210 and proceeds to step 220 where data structure protection logic 130 receives a first software instruction. This instruction identifies the software data structure to be protected, identifies its location and size, and an action to be performed.

The method proceeds to step 230, where data structure protection logic 130 performs a first error detection on a software data structure to generate a first result in response to the first software instruction. According to an embodiment, the error detection may include one or more of a repetition code, a parity bit, a checksum, a cyclic redundancy check (CRC), a cryptographic hash function, and an error-correcting code as are known in the art.

The method proceeds to step 240 where data structure protection logic 130 stores the software data structure and the first result in memory.

In step 250 data structure protection logic 130 receives a second software instruction. This instruction indicates that the software data structure is going to be used thus the structure itself is to be validated apriori.

The method proceeds to step 260 where data structure protection logic 130 retrieves the software data structure and the first result in response to the second software instruction. In step 270, data structure protection logic 130 performs a second error detection on the retrieved software data structure to generate a second result.

The method proceeds to step 280 where data structure protection logic 130 compares the second result with the first result. If the first and second results match, the software data structure is valid and the software program may proceed to use the data structure. If however, the results do not match, the software data structure is invalid and the software program is not permitted to use the software data structure. An error reporting mechanism, such as existing machine check architecture (MCA) may be used to indicate an invalid data structure. The method then ends at step 290.

For illustrative purposes, and not limitation, an example method for protecting software data structures in accordance with an embodiment is described below. In this example, the software data structure is an 11-byte data structure such as an array, and the error detection result is stored as a 12^{th} byte. It is to be appreciated that the embodiments are not limited to this 11-byte data structure and additional byte result and any combination is possible. Based on the description provided herein, a person skilled in the relevant art(s) will understand how to practice software data structure protection in accordance with embodiments in processor systems with various types of software data structures and various ratios of data structure to result data.

Once an 11-byte data structure is created and populated (or re-populated) with data, a first instruction is received by a hardware mechanism, data structure protection logic 130, that identifies the data structure to be protected. The instruction may be a special operation code or a compiler option that includes an address to identify the beginning point, the size of the data structure, for example, 11 bytes, and an action such as create (e.g., create protection for a new data structure or a recently repopulated data structure). Data structure protection logic 130 locates, retrieves, and performs an error detection on the 11-byte data structure.

In this example, a checksum is implemented to detect errors and the result of the checksum is stored in a 12^{th} byte. The 11-byte data structure and the 12^{th} byte result are written to memory. Memory may include main memory, or L1, L2 or L3 cache.

When any portion of the 11-byte data structure is to be used by a software program, data structure protection logic 130 receives a second instruction that also indicates a beginning point, size, and action to be taken. The entire 11-byte structure and the 12^{th} byte result are read from memory. A second error detection is performed on the 11-byte structure producing a second result. Data structure protection logic 130 compares the second result with the first result. If the results are the same, the data structure is coherent and valid and the data structure may be used by the software program. If however, the results are not the same, the data structure is invalid and the software is not permitted to use the data structure. An error is reported using MCA or equivalent.

Using a fixed cache line basis to retrieve the data structure and perform error detection would result in improved speed efficiencies. In this example, data structure protection logic 130 may be configured to use a 64-byte cache-line. Thus 8-byte portions of the 11-byte could be retrieved in parallel, error detection performed in parallel, and stored in parallel. Padding such as inserting zeros may be necessary. In another embodiment, the software data structure comprises a plurality of portions, and data structure protection logic 130 includes performing, by the one or more processing devices in parallel, a first error detection on a portion of a software structure to generate a first result in response to receipt of a first software instruction, and storing, by the one or more processing devices in parallel, a portion of the software structure in memory, In another embodiment, the software data structure comprises a plurality of portions, and data structure protection logic 130 further includes retrieving, by the one or more processing devices in parallel, a portion of the software structure, and performing, by the one or more processing devices in parallel, the second error detection on a portion of the software structure.

In another embodiment, the first software instruction and the second software instruction correlate to a security privilege level. Many computer systems have various security privilege levels for instructions. For example, a level-3 may indicate OS-level instructions such as kernel instructions. Other levels such as a level-0 may indicate user-level instructions such as software application program instructions. Data structure protection logic 130 may respond to instructions at a specified security privilege level to protect software data structures in various security privilege spaces.

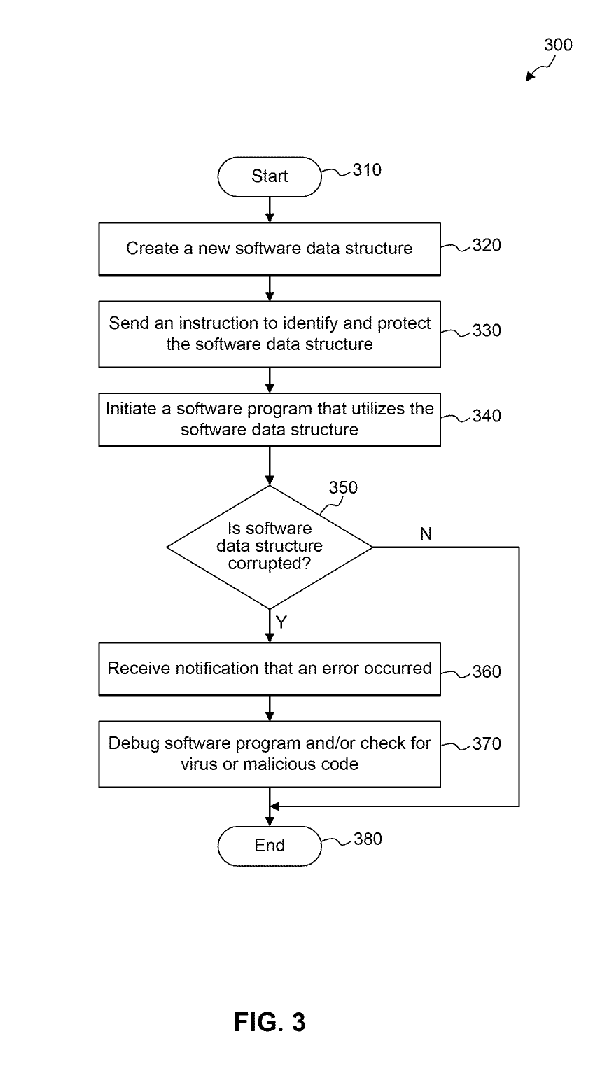

For illustrative purposes, and not limitation, another example method for a user or software developer protecting software data structures in accordance with an embodiment is described below. FIG. 3 is a flow chart illustrating steps by which a user or software developer utilizes an embodiment.

The method begins at step 310 and proceeds to step 320 where a user creates a new software data structure. As a parallel to the previous example, the software data structure is an 11-byte array with the first result stored in a 12^{th} byte. As mentioned earlier, any combination of sizes are possible between the size of the software data structure and the size of the result.

The method proceeds to step 330 where the user causes an instruction to be sent, and the instruction identifies the software data structure that is to be protected. Thus data structure protection logic 130 receives a first instruction as described earlier, finds the array in memory, performs a first error detection on the 11-byte array, and places the first result in the 12^{th} byte. Both the 11-byte array and the first result are stored in memory. At this point the array structure is protected.

The method proceeds to step 340 where the user initiates a software program that utilizes the software data structure. Before the software data structure, the array, is accessed, it is first checked to determine if it is valid or uncorrupted. Data structure protection logic 130 detects corruption of the entire array that would otherwise not be detected. Data structure protection logic 130 receives a second instruction as described earlier that results in the 11-byte array and 12^{th} byte first result being retrieved from memory. A second error detection is performed on the 11-byte array that generates a second result. The first and second results are then compared.

The method proceeds to decision step 350. If the first and second results are the same, then the software data structure has been validated and the software data structure is not corrupted. Thus the software program proceeds to use the software data structure as the user intended, and the method proceeds to step 380 where it ends.

If however, the first and second results are not the same, then the software data structure has been compromised or corrupted and the method proceeds to step 360 where the user receives an indication that an error has occurred. Thus the software program cannot proceed.

The method proceeds to step 370 where the user now checks for accidental code errors and/or checks for a virus or malicious code. Now the user has an indication of where a problem may exist, for example, in the software data structure itself, in the software code that generated the data structure, populated the data structure, or in the software code that attempted to access the software code. This is a significant benefit for users/software developers as they work to isolate sources of the problem, resolve problems in the code, or weaknesses in the security of the computing system, for example. The method proceeds to step 380 where it ends.

For illustrative purposes, and not limitation, another example method for protecting software data structures in accordance with an embodiment is described below. In this example, the software data structure is a data stack as is well known in the art.

When a software program runs, subroutines are typically called, executed, and then control is returned to the software program. When a call instruction is received, call data are retrieved from registers and pushed onto a data stack. In this example data structure protection logic 130 receives a first instruction that identifies the call data in the stack that needs to be protected, for example, read-only data. The first instruction may be a new operation code or a modified call operation code, for example. Data structure protection logic 130 performs an error detection such as a checksum on the call data in the data stack, generates a first result, and stores the call data and the first result in the data stack.

After a subroutine is executed, the call data are popped or removed from the data stack, and control is returned to the software program. In this example, before the call data are popped, data structure protection logic 130 receives a second instruction to validate the data stack. In an embodiment, the second software instruction is a return, and the first result is stored in a data stack. It retrieves the call data from the data stack, performs a second checksum on the call data, and generates a second result. Data structure protection logic 130 compares the second result with the first result. If the results match, the data stack is valid and control is returned to the software program. If however, the results do not match, then an error has occurred and the data stack is invalid. Error messages are sent accordingly.

Some subroutines are nested and run subroutines within a subroutine. When this occurs, data structure protection logic 130 may produce several nested first results. If the call instruction results in a nested subroutine, for example, then data structure protection logic 130 may perform several first checksums corresponding with the nested subroutines, and generating corresponding first results each of which are stored or nested accordingly in the data stack. Consequently, the corresponding second checksums and second results may be performed and compared accordingly. In another embodiment, one or more nested first results are stored in the call stack.

For illustrative purposes, and not limitation, a final example method for protecting software data structures in accordance with an embodiment is described below. In this example, the software data structure is an accelerated processing unit (APU) data structure, although one skilled in the relevant arts will appreciate that other data structures can be utilized. These APU data structures may be passed between a central processing unit (CPU) and a graphics processing unit (GPU). An example of an APU data structure includes a pointer. The ability to pass an APU data structure between a CPU and a GPU utilizing data structure protection logic 130 to check the validity of the structure provides significant speed and security compared to software verification methods.

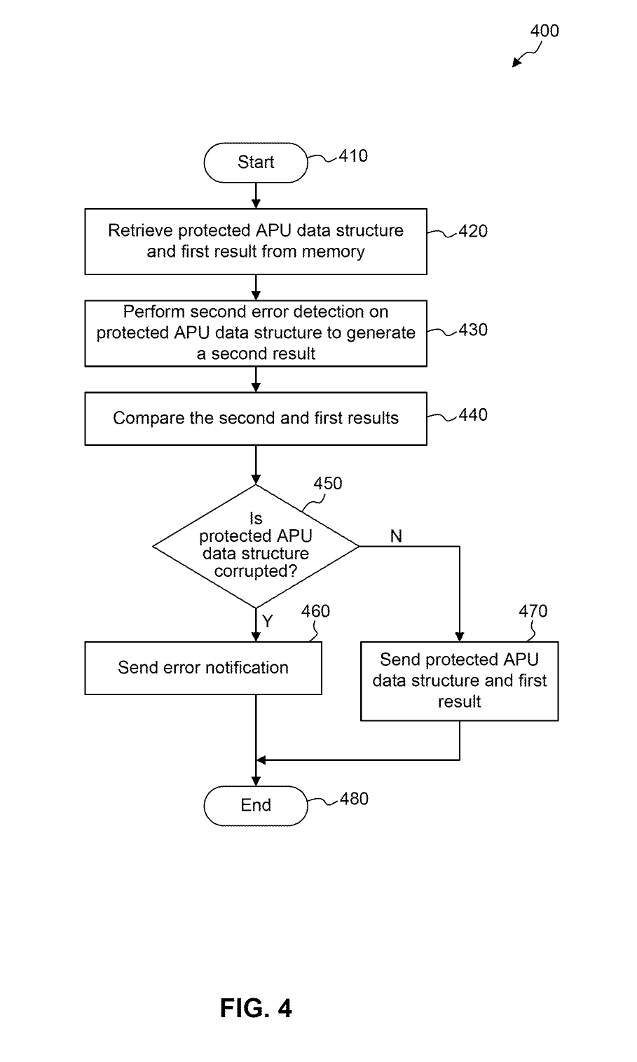

FIG. 4 is a flow chart illustrating steps by which a heterogeneous architecture structure is protected in accordance with an embodiment. In this example, an APU data structure is being passed from a CPU to a GPU. The method begins at step 410 where an APU data structure is already protected. That is, the APU data structure has been created, a first error detection has been performed by data structure protection logic 130, and the first result as well as the APU data structure have been saved in memory.

The method proceeds to step 420 where the CPU responds to instructions that the APU data structure is to be sent to the GPU. The CPU retrieves the protected APU data structure and the first result from memory. The method proceeds to step 430 where the CPU, e.g., data structure protection logic 130 in the CPU, performs a second error detection on the protected APU data structure to generate a second result.

The method proceeds to step 440 where the first and second results are compared. At decision step 450, if the results are different, then the APU data structure has been corrupted. The method proceeds to step 460 where the CPU does not send the APU data structure; it generates an error notification and sends an indication accordingly. The method ends at step 480.

If at step 450, the first and second results are the same, then the APU data structure is not corrupted, and the method proceeds to step 470 where the CPU sends the protected and valid APU data structure and the first result to the GPU. The method ends at step 480.

When the GPU receives the APU data structure (not shown), the GPU may perform an equivalent validation check to ensure that it is not corrupted. This provides a level of software data structure security so that errors in the data structure may be readily identified and then resolved.

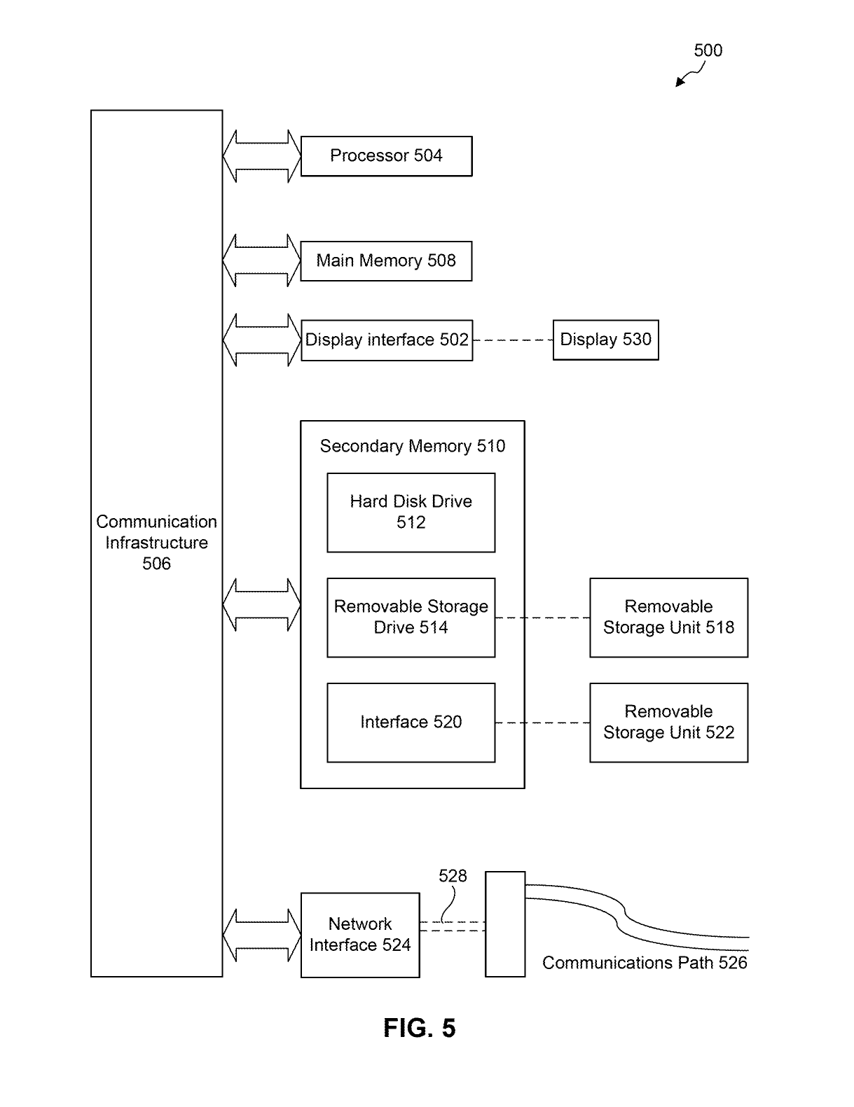

Various aspects of the disclosure can be implemented by software, firmware, hardware, or a combination thereof. FIG. 5 illustrates an example computer system 500 in which the embodiments, or portions thereof, can be implemented as computer-readable code. For example, the method illustrated by flowcharts 200 and 400 of FIGS. 2 and 4, as well as portions of flowchart 300 of FIG. 3 can be implemented in system 500. Various embodiments are described in terms of this example computer system 500. After reading this description, it will become apparent to a person skilled in the relevant art how to implement the embodiments using other computer systems and/or computer architectures.

Computer system 500 includes one or more processors, such as processor 504. Processor 504 can be a special purpose or a general purpose processor. Processor 504 is connected to a communication infrastructure 506 (for example, a bus or network).

Computer system 500 also includes a main memory 508, such as random access memory (RAM), and may also include a secondary memory 510. Secondary memory 510 may include, for example, a hard disk drive 512, a removable storage drive 514, and/or a memory stick. Removable storage drive 514 may comprise a floppy disk drive, a magnetic tape drive, an optical disk drive, a flash memory, or the like. The removable storage drive 514 reads from and/or writes to a removable storage unit 518 in a well-known manner. Removable storage unit 518 may comprise a floppy disk, magnetic tape, optical disk, etc. that is read by and written to by removable storage drive 514. As will be appreciated by persons skilled in the relevant art(s), removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 that allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 are in the form of signals that may be electronic, electromagnetic, optical, or other signals capable of being received by communications interface 524. These signals are provided to communications interface 324 via a communications path 526. Communications path 526 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 518, removable storage unit 522, and a hard disk installed in hard disk drive 512. Signals carried over communications path 526 can also embody the logic described herein. Computer program medium and computer usable medium can also refer to memories, such as main memory 508 and secondary memory 510, which can be memory semiconductors (e.g. DRAMs, etc.). These computer program products are means for providing software to computer system 500.

Computer programs (also called computer control logic) are stored in main memory 508 and/or secondary memory 510. Computer programs may also be received via communications interface 524. Such computer programs, when executed, enable computer system 500 to implement the embodiments as discussed herein. In particular, the computer programs, when executed, enable processor 504 to implement the disclosed processes, such as the steps in the methods illustrated by flowcharts 200 of FIG. 2, 400 of FIG. 4, and portions of 300 of FIG. 3 as discussed above. Accordingly, such computer programs represent controllers of the computer system 500. Where the embodiments are implemented using software, the software may be stored in a computer program product and loaded into computer system 500 using removable storage drive 514, interface 520, hard drive 512 or communications interface 524. This can be accomplished, for example, through the use of general-programming languages (such as C or C++), hardware-description languages (HDL) including Verilog HDL, VHDL, Altera HDL (AHDL) and so on, or other available programming and/or schematic-capture tools (such as, circuit-capture tools). The computer program code can be disposed in any known computer-readable medium including semiconductor, magnetic disk, or optical disk (such as, CD-ROM, DVD-ROM). As such, the code can be transmitted over communication networks including the Internet and internets. It is understood that the functions accomplished and/or structure provided by the systems and techniques described above can be represented in a core (such as a processing-unit core) that is embodied in program code and may be transformed to hardware as part of the production of integrated circuits.

Embodiments are also directed to computer program products comprising software stored on any computer useable medium. Such software, when executed in one or more data processing device, causes a data processing device(s) to operate as described herein. Embodiments employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A method comprising:
retrieving, by one or more processing devices, a software data structure and a first result in response to receipt of a software instruction;
performing, by the one or more processing devices, an error detection on the retrieved software data structure to generate a second result; and
determining, by the one or more processing devices, whether an error is present in the software data structure based on a comparison of the second result with the first result.

2. The method of claim 1, further comprising:
performing, by the one or more processing devices, another error detection on the software data structure to generate the first result in response to receipt of another software instruction issued prior to the software instruction; and
storing, by the one or more processing devices, the software data structure and the first result in memory.

3. The method of claim 1, wherein the software data structure comprises a plurality of portions, the method further comprising:
retrieving, by the one or more processing devices in parallel, a portion of the software structure; and
performing, by the one or more processing devices in parallel, the error detection on a portion of the software structure.

4. The method of claim 1, wherein the software data structure comprises a plurality of portions, the method further comprising:
performing, by the one or more processing devices in parallel, another error detection on a portion of the software structure to generate a first result in response to receipt of another software instruction issued prior to the software instruction; and
storing, by the one or more processing devices in parallel, a portion of the software structure in memory.

5. The method of claim 1, wherein the error detection includes one or more of a repetition code, a parity bit, a checksum, a cyclic redundancy check (CRC), a cryptographic hash function, and an error-correcting code.

6. The method of claim 1, wherein performing the error detection on the software data structure further comprises one or more of a read only software data structure, a stack structure, an accelerated processing unit (APU) data structure, an array structure, and a tree structure.

7. The method of claim 1, wherein the software instruction is a return, and the first result is stored in a data stack.

8. The method of claim 7, further comprising one or more nested first results stored in the data stack.

9. The method of claim 1, wherein the software instruction correlates to a security privilege level.

10. A processing unit comprising:
a hardware mechanism configured to perform operations comprising:
retrieve a software data structure and a first result in response to receipt of a software instruction;
perform an error detection on the retrieved software data structure to generate a second result; and
determine whether an error is present in the software data structure based on a comparison of the second result with the first result.

11. The processing unit of claim 10 further comprising:
a hardware mechanism configured to perform operations comprising:
perform another error detection on the software data structure to generate a first result in response to receipt of another software instruction issued prior to the software instruction; and
store the software data structure and the first result in memory.

12. The processing unit of claim 10, wherein the software data structure comprises a plurality of portions, further comprising:
a hardware mechanism configured to:
retrieve in parallel, a portion of the software structure; and
perform in parallel, the error detection on a portion of the software structure.

13. The processing unit of claim 10, wherein the software data structure comprises a plurality of portions, further comprising:
a hardware mechanism configured to:
perform in parallel, another error detection on a portion of the software data structure to generate a first result in response to receipt of another software instruction issued prior to the software instruction; and
store in parallel, a portion of the software structure in memory.

14. The processing unit of claim 10, wherein the error detection includes one or more of a repetition code, a parity bit, a checksum, a cyclic redundancy check (CRC), a cryptographic hash function, and an error-correcting code.

15. The processing unit of claim 10, wherein the software data structure comprises one or more of a read only software data structure, a stack structure, an accelerated processing unit (APU) data structure, an array structure, and a tree structure.

16. The processing unit of claim 10, wherein the software data structure is a data stack, and the first result is stored in the data stack.

17. The processing unit of claim 16, further comprising one or more nested first results stored in the data stack.

18. The processing unit of claim 10, wherein the software instruction correlates to a security privilege level.

19. A computer-readable storage device having stored thereon instructions, execution of which, by a computing device, cause the computing device to perform operations comprising:
retrieving a software data structure and a first result in response to receipt of a software instruction;
performing an error detection on the retrieved software data structure to generate a second result; and
determining whether an error is present in the software data structure based on a comparison of the second result with the first result.

20. The computer-readable storage device of claim 19, further comprising:
performing another error detection on the software data structure to generate a first result in response to receipt of another software instruction issued prior to the software instruction; and
storing the software data structure and the first result in memory.
